(19) United States
(12) Patent Application Publication
(10) Pub. No.: US 2012/0183884 A1
(43) Pub. Date: Jul. 19, 2012

(54) SEPARATOR AND SOFC HAVING THE SAME

(76) Inventors: Kwang-Jin Park, Yongin-si (KR); Sang-Jun Kong, Yongin-si (KR); Tae-Ho Kwon, Yongin-si (KR)

(21) Appl. No.: 13/244,216

(22) Filed: Sep. 23, 2011

Related U.S. Application Data
(60) Provisional application No. 61/432,579, filed on Jan. 13, 2011.

(51) Int. Cl. H01M 8/04; H01M 2/18

(52) U.S. Cl. 429/513; 429/516

(57) ABSTRACT

Disclosed is a separator to seal a fuel chamber and a solid oxide fuel cell (SOFC) having the same. The separator for the SOFC includes a through hole to accommodate a unit cell and a groove formed in an inside surface of the through hole. According to the present invention, a groove where a sealing material is disposed is formed in a portion to be welded to stably form a filler metal. Further, a slanting part formed on the groove presses the sealing material in a direction to the unit cell to improve sealing efficiency.

### CROSS-REFERENCE TO RELATED APPLICATION

This application claims priority to and the benefit of U.S. Provisional Patent Application No. 61/432,579, filed on Jan. 13, 2011, in the United States Patent and Trademark Office, the entire content of which is incorporated herein by reference

### BACKGROUND

1. Field

The embodiment relates to a separator and a solid oxide fuel cell (SOFC) having the same.

2. Description of Related Art

Generally, a fuel cell is a device which converts chemical energy of fuel into electric energy via a chemical reaction and is a type of a generator continually generating electricity as long as fuel is provided. When air including oxygen is provided to a cathode of a unit cell, and fuel is provided to an anode, an inverse reaction to electrolysis of water occurs through an electrolyte layer between the anode and the cathode to produce electricity.

However, since electricity generated in the single unit cell does not have a high enough voltage to be used, a plurality of unit cells are generally deposited or integrated into a stack for use.

When a plurality of tubular unit cells of SOFCs are formed into a stack, a separator may be used to divide chambers of gas provided to the respective unit cells.

### SUMMARY

An aspect of the present invention is to provide a secure sealing structure between a separator to separate gas chambers and a tubular cell to improve sealing efficiency when a stack is formed of tubular unit cells.

According to an aspect of the present invention, there is provided a separator for a solid oxide fuel cell (SOFC) including a through hole to accommodate a unit cell and a groove formed on an inside surface of the through hole.

The groove may be formed along the inside surface of the through hole to have a regular longitudinal cross-sectional shape.

Further, the groove may include an upper pressing surface and a lower supporting surface.

Further, the pressing surface and the separator may form an angle of 30 degrees to 60 degrees.

In addition, the supporting surface and the separator may form an angle of 0 degree to 50 degrees.

According to another aspect of the present invention, a separator for an SOFC may include a through hole to accommodate a unit cell. Here, a supporting part having a smaller diameter than an upper part of the through hole may be formed on a lower part of the through hole. The through hole may be formed to have a decreasing diameter downwards.

According to another aspect of the present invention, an SOFC includes a first fuel chamber, a second fuel chamber, a unit cell, a first oxidant chamber, a second oxidant chamber, a separator, and a filler metal.

The first fuel chamber is provided with fuel from an outside. The unit cell is provided with fuel through the first fuel chamber to conduct oxidation. The second fuel chamber functions as a path through which collected off gas discharged from the unit cell is discharged to the outside. An oxidizing agent is introduced to the first oxidant chamber from the outside. The second oxidant chamber is provided with the oxidizing agent through the first oxidant chamber to conduct reduction on an outside surface of the unit cell and includes a discharge pipe to discharge the oxidizing agent to the outside. The separator divides the second fuel chamber and the second oxidant chamber, and includes a through hole to accommodate the unit cell and a groove formed on an inside surface of the through hole. The filler metal is disposed between the inside surface of the through hole and the outside surface of the unit cell.

The groove may be formed along the inside surface of the through hole to have a regular longitudinal cross-sectional shape.

Further, the groove may include an upper pressing surface and a lower supporting surface.

Further, the pressing surface and the separator may form an angle of 30 degrees to 60 degrees.

In addition, the supporting surface and the separator may form an angle of 0 degree to 50 degrees.

The filler metal may have a coefficient of thermal expansion different about 5% from a coefficient of thermal expansion of the unit cell.

Further, the separator may have a coefficient of thermal expansion different about 5% from the coefficient of thermal expansion of the unit cell.

At least two separators may be formed, and the filler metal may be further formed between the separators.

As described above, according to exemplary embodiments of the present invention, a groove where a sealing material is disposed is formed in a portion to be welded to stably form a filler metal. Further, a slanting part formed on the groove presses the sealing material in a direction to the unit cell to improve sealing efficiency.

According to exemplary embodiments of the present invention, a double sealing structure is provided to improve sealing efficiency and to be stably maintained under high-temperature and high-pressure conditions.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic view illustrating a stack using a tubular unit cell of a solid oxide fuel cell (SOFC);

FIG. 2 is a schematic transverse cross-sectional view illustrating the stack of FIG. 1;

FIG. 3 is a schematic longitudinal cross-sectional view illustrating a sealing structure between a separator and a unit cell according to a comparative example;

FIG. 4A is a schematic longitudinal cross-sectional view illustrating a sealing part of a separator according to an exemplary example of the present invention;

FIG. 4B is a schematic longitudinal cross-sectional view illustrating a sealing structure between the separator and a unit cell of FIG. 4A;

FIG. 5 is a schematic longitudinal cross-sectional view illustrating a sealing structure between a separator and a unit cell according to another comparative example;

FIG. 6 is a schematic longitudinal cross-sectional view illustrating a double sealing structure according to another exemplary embodiment;

FIG. 7 is a schematic longitudinal cross-sectional view illustrating a sealing structure between a separator and a unit cell according to still another exemplary embodiment; and

FIGS. 8 to 11 are schematic longitudinal cross-sectional views respectively illustrating a sealing structure of a separator and a unit cell according to yet another exemplary embodiment.

### DETAILED DESCRIPTION OF THE EMBODIMENTS

Hereinafter, exemplary embodiments of the present invention will be described in detail with reference to the accompanying drawings. In the specification, terms to indicate directions “up,” “down,” “right,” and “left” are based on directions in the drawings unless the context clearly indicates otherwise. Further, like reference numerals refer to like elements in the embodiments. In the drawings, the size and relative sizes of layers and regions may be exaggerated for clarity.

Generally, a fuel cell includes a fuel conversion system to reform and provide fuel, including a reformer and a reactor, and a fuel cell module. Here, the fuel cell module refers to an assembly including a fuel cell stack which converts chemical energy into electric energy and heat energy through electrochemical processes. More specifically, the fuel cell module includes a fuel cell stack, a pipe where fuel, oxides, cooling water, a discharge, or the like travels, a wire where electricity generated by the stack is transferred, a component to control or monitor the stack, a component to measure abnormalities in the stack, or the like. Embodiments of the present invention disclose a sealing structure of a separator and a unit cell in the fuel cell stack generating electricity through an electrochemical reaction using a single unit of a plurality of unit cells. Hereinafter, exemplary embodiments of the present invention will be further described.

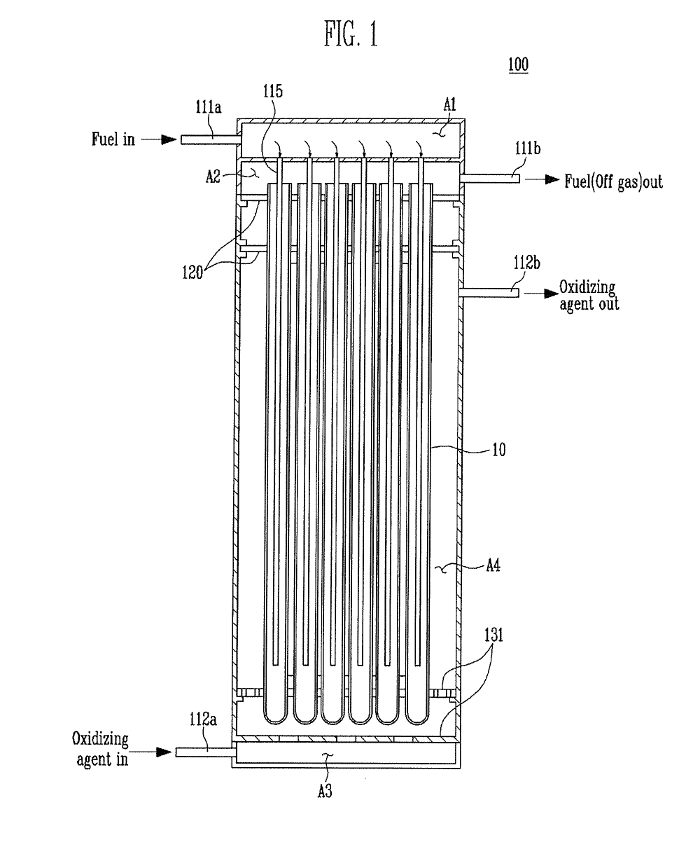

Referring to FIGS. 1 and 2, a unit cell 10 and a passage 115 are described. FIG. 1 is a schematic view illustrating a stack using a tubular unit cell of a solid oxide fuel cell (SOFC), and FIG. 2 is a schematic transverse cross-sectional view illustrating the stack of FIG. 1.

The unit cell 10 is a configuration which is provided with reformed fuel from a fuel conversion system and produces electricity via oxidation. As shown in FIGS. 1 and 2, the unit cell 10 is generally tubular. A tubular fuel cell is anode-supported, being formed of an anode, an electrolyte, and a cathode stacked in a radial shape based on a central axis, or is cathode-supported, being formed of a cathode, an electrolyte, and an anode stacked in order. The present embodiment is described with an anode-supported fuel cell for convenience of description, but is not limited thereto. That is, an embodiment using a cathode-supported unit cell has an opposite configuration where fuel and oxidants travel to the present embodiment and could also be used in conjunction with embodiments of the present invention.

The unit cell 10 has a closed lower end. Since a detailed configuration and operations of the unit cell 10 are not associated with the scope of the present invention, descriptions thereof are omitted.

The unit cell 10 includes the interior passage 115. The passage 115 is generally cylindrical having a diameter smaller than an inside diameter of the unit cell 10. The passage 115 is within the unit cell 10 and has opposite open ends. A regular interval is maintained between the passage 115 and the unit cell 10 to form a path through which gas and/or a fluid flows.

An upper end of the passage 115 is connected to a first fuel chamber A1 to allow fluid flow from the first fuel chamber into the passage, and an upper end of the unit cell 10 is connected to a second fuel chamber A2 to allow fluid flow.

Referring to FIGS. 1 and 2, the first fuel chamber A1 and the second fuel chamber A2 are described. The unit cell 10 is provided with fuel including hydrogen as a main component and generates electrons via oxidation. Here, the first fuel chamber A1 is located in a top position of the fuel cell stack 100 and is provided with fuel from a fuel supplier, such as a fuel conversion system, through a fuel supply pipe 111a.

The passage 115 is connected to the first fuel chamber A1 at a lower part of the first fuel chamber A1 so that a fluid flows therethrough. Fuel provided to the first fuel chamber A1 is distributed and flows to each of a plurality of passages 115 connected to the lower part of the first fuel chamber A1.

The second fuel chamber A2 is formed in a level under the first fuel chamber A1. Since the second fuel chamber A2 is connected to the upper end of the unit cell 10 so that a fluid flows, off gas from the unit cell 10 after oxidation is introduced to the second fuel chamber A2. The second fuel chamber A2 includes an off gas discharge pipe 111b to discharge introduced off gas therethrough.

In other words, the fuel including hydrogen as the main component is first introduced to the first fuel chamber A1 through the fuel supply pipe 111a and is distributed to each passage 115. The fuel introduced to the passage 115 is oxidized, going up from a lower end of the passage 115 along a path formed between the passage 115 and an inside surface of the unit cell 10. The off gas after the oxidation is introduced from the upper end of the unit cell 10 to the second fuel chamber A2 and is discharged through the off gas discharge pipe 111b.

Referring to FIGS. 1 and 2, a first oxidant chamber A3 and a second oxidant chamber A4 are described.

The first oxidant chamber A3 is located in a bottom position of the fuel cell stack 100 and is an area to which an oxidizing agent introduced through an oxidant supply pipe from the outside is first introduced. A distribution part 131 is formed in an upper part of the first oxidant chamber A3 and may include a plate having a plurality of through holes. The distribution part 131 functions to uniformly provide an oxidizing agent to the second oxidant chamber A4 based on a number and a position of through holes. Here, the distribution part 131 may be formed of a porous material or in a type of forming an oxidant transfer path. The oxidizing agent supplied through the oxidant supply pipe 112a includes air, pure oxygen (O₂), or gas including oxygen.

The second oxidant chamber A4 is an area surrounding an external side of the unit cell 10. The oxidizing agent passing through the distribution part 131 is introduced to the second oxidant chamber A4. The oxidizing agent is reduced on an outside surface of the unit cell 10, that is, the cathode in the present embodiment, going up from a lower part of the second oxidant chamber A4 and generates oxygen ions. The oxidizing agent traveling to an upper part of the second oxidant chamber A4 is discharged through an oxidant discharge pipe 112b formed on a lateral side.

A lower part of the second fuel chamber A2 and the upper part of the second oxidant chamber A4 are divided from each other and sealed by at least one separator 120. The separator 120 is formed in a plate shape. Further, as shown in FIG. 2, the separator 120 is formed with the same number of through holes 121 as a number of unit cells 10 in the stack 100 to accommodate the unit cells 10. In manufacturing the fuel cell stack 100, the unit cells 10 are inserted into the through holes 121 of the separator 120, and the through holes 121 and an outside surface of the unit cells 10 are welded to form the separator 120, by which the second fuel chamber A2 and the second oxidant chamber A4 are divided from each other and sealed.

In operation of the fuel cell, when hydrogen, which is the main component of the fuel, is in contact with oxygen included in the oxidizing agent, undesired oxidation or an explosive reaction may occur. Thus, a sealing structure between the second fuel chamber A2 and the second oxidant chamber A4 is an important issue with respect to stability.

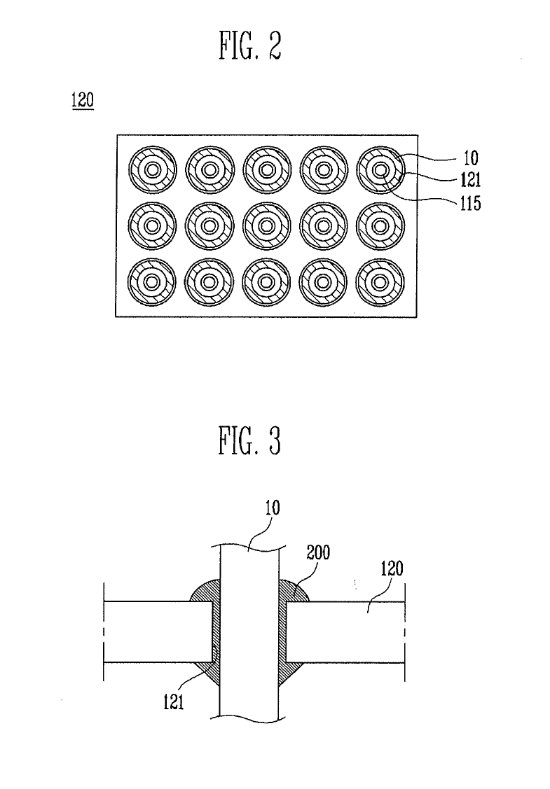

Referring to FIG. 3, a sealing structure of a separator according to a comparative example is described. FIG. 3 is a schematic longitudinal cross-sectional view illustrating a sealing structure between a separator 120 and a unit cell 10 according to the comparative example.

Generally, a through hole 121 in a cylindrical shape is formed in the separator 120 to accommodate the unit cell 10. The unit cell 10 is accommodated in the through hole 121, and then a filler metal 200 is formed between an inside surface of the through hole 121 and an outside surface of the unit cell 10. The filler metal 200 is formed through brazing and functions to fix and seal the unit cell 10 and the separator 120.

However, in the sealing structure, only a gap between the separator 120 and the unit cell 10 are sealed, but the filler metal 200 may not be adequately supported. Further, the only force exerted on the filler metal 200 until the filler metal 200 is coagulated is gravity and surface tension of the materials of the filler metal 200. Thus, the filler metal 200 may not have a closed structure after the coagulation, and a bond between the unit cell 10 and the separator 120 may not be sufficiently secure.

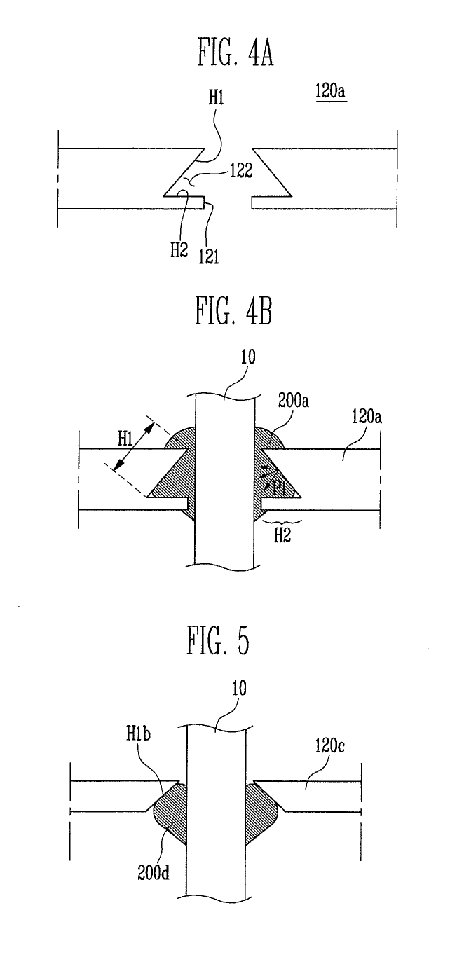

Referring to FIGS. 4A to 5, a sealing structure between a separator 120a and a unit cell 10 according to an exemplary embodiment is described. FIG. 4A is a schematic longitudinal cross-sectional view illustrating the separator according to the exemplary example, FIG. 4B is a schematic longitudinal cross-sectional view illustrating the sealing structure of the separator and the unit cell of FIG. 4A, and FIG. 5 is a schematic longitudinal cross-sectional view illustrating a sealing structure of a separator and a unit cell according to another comparative example.

A through hole 121 is formed in the separator 120a to accommodate the unit cell 10 and the number of through holes is equal to the number of unit cells 10 provided in the stack. A groove 122 is formed on an inside surface of the through hole 121 (i.e., on a side wall of the separator defining the through hole 121). The groove 122 is formed along the inside surface of the through hole 121. In one embodiment, the groove 122 may be formed to have a uniform shape from a longitudinal cross-section in order to uniformly form a filler metal.

As shown in the embodiment of FIGS. 4A and 4B, the groove 122 includes an upper pressing surface H1 and a supporting surface H2. In one embodiment, the pressing surface H1 is formed to be angled with respect to the separator 120a. The supporting surface H2 is formed from one end of the pressing surface H1 that is substantially parallel with the separator 120a.

The unit cell 10 is accommodated in the through hole 121 formed in the separator 120a, and then the filler metal 200a is provided. The filler metal 200a is provided by introducing a sealing material 200a being fluid when heated to the through hole 121 through a sealing material injection device and coagulating the material.

The supporting surface H2 sufficiently supports the sealing material 200a which is not coagulated until the sealing material 200a is coagulated. The supporting surface H2 provides a sufficient surface where the sealing material 200a is attached and supported by surface tension.

The sealing material 200a swells before coagulated due to surface tension. Here, the pressing surface H1 presses the sealing material 200a in a direction P1 to the unit cell 10, reacting to swelling of the sealing material 200a, and the supporting surface H2 supports the sealing material 200a. As a result, a closeness of the filler metal 200a is improved due to the press of the pressing surface H1 and the support of the supporting surface H2. Accordingly, the coagulated filler metal 200a sufficiently seals a gap between the separator 120a and the unit cell 10.

FIG. 5 shows a separator 120 which does not have a supporting surface. In this instance, when a pressing surface H1b presses a sealing material 200d, there is no part to support the sealing material 200d which is not coagulated, and thus a filler metal 200d does not have improved closeness. Further, the sealing material 200d may flow into the fuel cell stack to contaminate it.

Coefficients of thermal expansion of components are relevant in the fuel cell due to the high-temperature operation conditions. In one embodiment, the unit cell, the separator, and the filler metal have coefficients of thermal expansion which are not considerably different. When any one of the unit cell, the separator, and the filler metal has a remarkably different coefficient of thermal expansion from the others, there may be a risk of generating a crack due to a high temperature when the fuel cell operates. In this instance, as described above, hydrogen from the fuel may be in contact with oxygen in the oxidizing agent to cause drastic oxidation or explosion.

Thus, the filler metal and the separator may respectively be formed of materials having coefficients of thermal expansion which are within about 5% of each other. Generally, the separator uses materials having a coefficient of thermal expansion within about 12 to 13×10⁻⁶/K, such as SUS 400 series and a Ni—Cr—Fe alloy. Here, the filler metal 200a is formed of a sealing material containing SiO₂, B₂O₃, Al₂O₃, or the like, adjusting an amount of SiO₂, B₂O₃, Al₂O₃, or the like to have a coefficient of thermal expansion of within about 5% with respect to the coefficient of thermal expansion of the separator 120a.

Hereinafter, a sealing structure between a separator and a unit cell according to another exemplary embodiment is described with reference to FIG. 6. FIG. 6 is a schematic longitudinal cross-sectional view illustrating a double sealing structure according to the other exemplary embodiment.

In the present embodiment, double separators 120a are formed. Here, a filler metal 200b is formed not only in a groove (refer to 122 in FIG. 4A) of the separators 120a but also between the two separators 120a.

First, the unit cell 10 is inserted into a through hole of a lower separator 120a, and a sealing material is injected between a groove of the lower separator 120 and the unit cell 10 and is applied thinly on the lower separator 120a. Then, an upper separator 120a is placed on the lower separator 120a. The sealing material is injected between a groove of the upper separator 120a and the unit cell 10. The sealing material is coagulated to form the filler metal 200b.

The sealing material applied between the two separators 120a may be formed with a minimum thickness. When the filler metal 200b applied between the separators 120a becomes thicker, a crack may increasingly occur in the filler metal 200b due to a difference in coefficient of thermal expansion between the separators 120a and the filler metal 200b formed between the separators 120a. Thus, the filler metal 200b between the separators 120a may be formed to have a thickness of 1 mm or less.

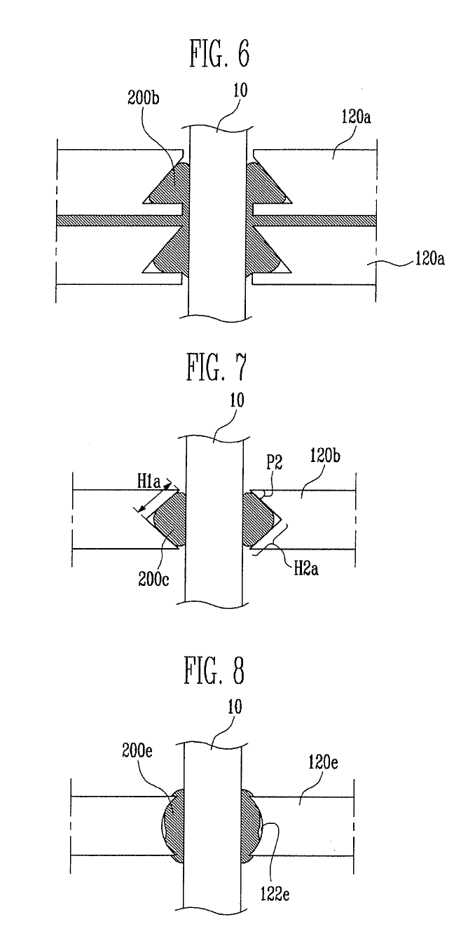

Referring to FIG. 7, a sealing structure between a separator and a unit cell according to still another exemplary embodiment is described. FIG. 7 is a schematic longitudinal cross-sectional view illustrating the sealing structure between the separator and the unit cell according to the still another exemplary embodiment.

In the present embodiment, a groove has a different structure than the previously described embodiments. First, like the above described embodiment, a pressing surface H1a is formed to be angled with respect to a peripheral or outer surface of the separator 120b. Additionally, a supporting surface H2a is formed to be angled with respect to a peripheral surface of the separator 120b, unlike the above-described embodiment. In this instance, the supporting surface H2a changes a direction of the force exerted by gravity on an uncoagulated sealing material 200c to a direction generally toward the unit cell 10.

The sealing material 200c is injected between the groove H1a and H2a and the unit cell 10 by a sealing material injection device. The sealing material is coagulated to form a filler metal 200c. Here, due to structural characteristics of the pressing surface H1a and the supporting surface H2a, the filler metal 200c has improved closeness. In other words, when the pressing surface H1a and the supporting surface H2a are formed to be angled with respect to a peripheral surface of the separator 200c, the injected sealing material is pressed in a direction generally towards the unit cell 10 to form a closely-knit filler metal 200c.

In one embodiment, the angle P2 between the pressing surface H1a and the separator 120b is between about 30 degrees and about 60 degrees. When the angle between the pressing surface H1a and the separator 120b is less than 30 degrees, the pressing surface H1a may not effectively press the sealing material 200c in the direction of the unit cell 10. When the angle is more than 60 degrees, the supporting surface H2a may become too steep so that a space of the groove formed by the pressing surface H1a and the supporting surface H2a may not include a sufficient amount of sealing material.

In one embodiment, the angle between the supporting surface H2a and the separator 120b may be about 50 degrees or less. When the angle between the supporting surface H2a and the separator 120b is more than about 50 degrees, an effect of closely attaching the sealing material 200c in the direction to the unit cell 10 increases, but the sealing material 200c may be less effectively supported.

Referring to FIGS. 8 and 9, a sealing structure between a separator and a unit cell according to yet additional exemplary embodiments are shown. FIGS. 8 and 9 are schematic longitudinal cross-sectional views respectively illustrating the sealing structure between the separator and the unit cell according to the yet other exemplary embodiments.

In the present embodiment, the separator 120e is formed with a groove 122e having a semicircular or arc-shaped longitudinal section on an inside surface of a through hole. An upper part of the groove 122e functions as a pressing surface, and a lower part thereof functions as a supporting surface. The groove 122e presses a sealing material 200e when it swells to improve closeness and supports the sealing material 200e so that it does not leak or creep downward.

In the embodiment with reference to FIG. 9, the separator 120f is formed with a groove 122f having an angular shaped or a generally U-shaped cross-section. In this instance, as compared with the sealing structure illustrated in FIG. 4B or FIG. 7, a sealing material 200f is less pressed, but a contact area between the separator 120f and the sealing material 200f increases due to the groove 122f to restrict fluidity of the sealing material 200f. Thus, the present embodiment has an effect of maximally preventing the sealing material 200f from leaking or creeping downward.

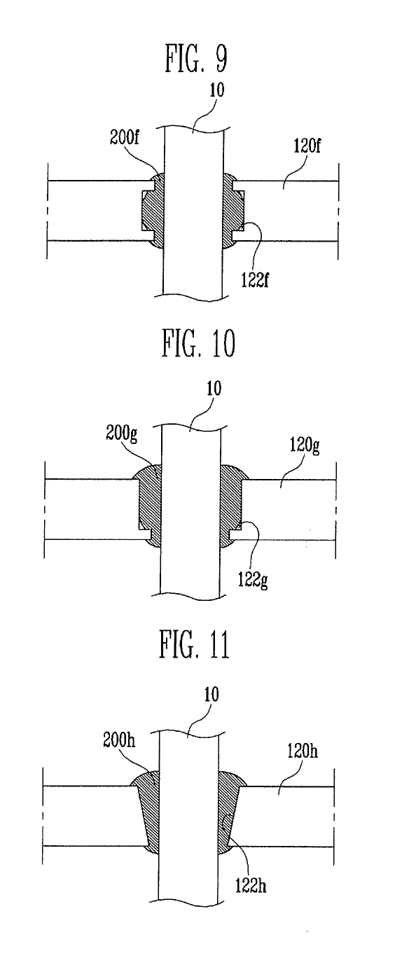

Referring to FIGS. 10 and 11, a sealing structure between a separator and a unit cell according to still another exemplary embodiment. FIGS. 10 and 11 are schematic longitudinal cross-sectional views respectively illustrating the sealing structure between the separator and the unit cell according to the still other exemplary embodiment.

As shown in FIG. 10, a supporting surface 122g having a smaller diameter than an upper part of a through hole is formed on a lower part of the through hole providing a generally L-shaped cross-section. The supporting surface 122g increases a contact area with a sealing material 200e and prevents the sealing material 200e from leaking or creeping downward.

As shown in FIG. 11, a supporting part is not separately formed, but a through hole is formed to have a decreasing diameter downwards to form a supporting surface 122h. In this instance, an interval between the unit cell 10 and the separator 120h decreases downwards to restrict fluidity of a sealing material 200h, thereby preventing the sealing material 200h from running down. Further, the supporting surface 122h improves closeness of the sealing material 200h, reacting to a force that the sealing material 200h tends to run down.

While the present invention has been described in connection with certain exemplary embodiments, it is to be understood that the invention is not limited to the disclosed embodiments, but, on the contrary, is intended to cover various modifications and equivalent arrangements of a separator and an SOFC having the same for sealing various fuels and oxidants chambers included within the spirit and scope of the appended claims, and equivalents thereof.

1. A fuel cell comprising:
a unit cell;
a separator supporting the unit cell, wherein the separator has a through hole through which the unit cell extends and wherein a side wall of the separator adjacent to the through hole has a groove; and
a filler metal in the groove of the separator and contacting the unit cell.

2. The fuel cell of claim 1, wherein the groove has a supporting surface which contacts the filler metal and a pressing surface extending from the support surface which contacts the filler metal.

3. The fuel cell of claim 2, wherein an angle between the pressing surface and a peripheral surface adjacent to the pressing surface is between about 30 degrees and about 60 degrees.

4. The fuel cell of claim 2, wherein an angle between the supporting surface and a peripheral surface of the separator adjacent to the supporting surface is between about 0 degrees to about 50 degrees.

5. The fuel cell of claim 2, wherein the supporting surface and the pressing surface generally form a V-shape.

6. The fuel cell of claim 1, wherein a cross-sectional shape of the groove is arc-shaped, substantially U-shaped or substantially L-shaped.

7. The fuel cell of claim 1, wherein opposite-facing side walls adjacent to the through hole of the separator are not parallel to each other.

8. The fuel cell of claim 1, wherein the groove is formed as an inclined side wall.

9. The fuel cell of claim 1, wherein the separator and the filler metal each comprise a material having a coefficient of thermal expansion which is within about 5% of each other.

10. The fuel cell of claim 1, further comprising at least one additional separator, wherein the at least one additional separator has a groove which contacts the filler metal.

11. The fuel cell of claim 10, wherein the filler material is located between and contacts the separator and the at least one additional separator.

12. The fuel cell of claim 1, further comprising:
a first fuel chamber for providing fuel to the unit cell;
a second fuel chamber for collecting gas from the unit cell to be discharged;
a first oxidant chamber for receiving an oxidizing agent; and
a second oxidant chamber in contact with the unit cell for receiving the oxidizing agent from the first oxidant chamber; wherein the separator is between the second fuel chamber and the second oxidant chamber.

13. The fuel cell of claim 1, wherein the fuel cell is a solid oxide fuel cell.

14. A separator for a fuel cell comprising a unit cell, wherein the separator comprises:
a body for supporting the unit cell, wherein the body has a through hole adapted to accommodate the unit cell extends and wherein a side wall of the separator adjacent to the through hole has a groove.

15. The separator of claim 14, wherein the groove has a supporting surface configured to hold a filler metal and a pressing surface extending from the supporting surface.

16. The fuel cell of claim 15, wherein an angle between the pressing surface and a peripheral surface of the separator adjacent to the pressing surface is between about 30 degrees and about 60 degrees.

17. The fuel cell of claim 15, wherein an between the supporting surface and a peripheral surface of the separator adjacent to the supporting surface is between about 0 degrees to about 50 degrees.

18. The fuel cell of claim 15, wherein the supporting surface and the pressing surface generally form a V-shape.

19. The fuel cell of claim 14, wherein a cross-sectional shape of the groove is arc-shaped, substantially U-shaped or substantially L-shaped.

20. The fuel cell of claim 14, wherein opposite-facing side walls adjacent to the through hole of the separator are not parallel to each other.
